(19) United States
(12) Patent Application Publication
(10) Pub. No.: US 2012/0064753 A1
(43) Pub. Date: Mar. 15, 2012

(54) SECURING DEVICE

(75) Inventor: YunLong Qiao, Singapore (SG)

(73) Assignee: 3M INNOVATIVE PROPERTIES COMPANY, St. Paul, MN (US)

(21) Appl. No.: 13/319,592

(22) PCT Filed: May 12, 2010
(86) PCT No.: PCT/US2010/034482

§ 371 Date: Nov. 9, 2011

(30) Foreign Application Priority Data
May 15, 2009 (SG) 200903346-5

(51) Int. Cl. H01R 13/62

(52) U.S. Cl. 439/345

(57) ABSTRACT

A securing device comprises a frame having a first extension, a second extension and a body connecting the first and the second extensions, a retainer device having a first retainer arm, a second retainer arm and a bridging arm connecting both first ends of the first to the second retainer arms, a plurality of coupling devices extending from the body of the frame, coupling both second ends of the first and the second retainer arms of the retainer device to the frame; and a plurality of locking devices incorporated in the frame, locking the frame to an electrical connector to which the frame is to be attached.

### TECHNICAL FIELD

The present invention relates to a securing device, in particular, a securing device for securing a removable mass storage device to an electrical connector.

### BACKGROUND

The demand for removable mass storage devices increases with the advent of new computers, cameras and other electronic equipment. As technology progresses, these electronic equipment become faster in terms of their processing speed, more powerful and complex in terms of features and smaller in size for better end-user experience. Accordingly, the removable mass storage devices made for such electronic equipment have to be faster in managing the data exchange and processing, be smaller in size as well as have more security features to prevent accidental misuse and data loss.

An example of such removable mass storage devices is a CompactFlash (trademark of CompactFlash Association (CFA)) card (also known as CF card) which uses flash memory to store the data. The CF cards are designed in compliance with the CFA Standard and are broadly classified into two types—Type I and Type II. Both the Type I and Type II of CF cards are 36.4 mm wide and 42.5 mm long. However, the Type I and Type II CF cards have a thickness of 3.3 mm and 5.0 mm respectively.

The current CF card has a Parallel Advanced Technology Attachment (ATA) interface while the next generation CF card (also known as “CFast”) will be updated to have a serial interface based on the Serial ATA (or also known as SATA) specification. This is because as the drive capacity becomes denser, the transfer speed of Parallel ATA (PATA) which has a maximum throughput of about 133 MB/second is not able to keep up with the speed of moving a large quantity of data on and off the storage device. The CFast card while retaining the form factor of the CF card, has an enhanced throughput of about 150 MB/second to about 300 MB/second due to the SATA interface, is therefore better able to meet the expectations of a faster storage device.

An important consideration when designing electrical connectors for use with the CF and/or CFast card (hereby collectively referred to as CF card) is the secure engagement of the CF card to the electrical connector when in use. The CF card can get disengaged from the electrical connector, e.g., due to the electronic equipment vibration or when the electronic equipment is accidentally dropped. For an electrical connector with a storage device ejector, the CF card can also be disengaged by the user ejecting the CF card accidentally by depressing the ejector. When the CF card is disengaged from the electrical connector, the data reading/writing, processing and/or transmission between the CF card and the electronic equipment may be affected resulting in data loss.

The present invention is directed to a securing device, in particular, a securing device for securing a removable mass storage device to an electrical connector.

### SUMMARY

It would be desirable to provide a securing device for securing a removable mass storage device to an electrical connector. It would also be desirable to provide a securing device that can be used with different types of removable mass storage devices, including but not limited to, the CF Type I, CF Type II and CFast card.

In accordance with one embodiment of the present invention, there is provided a securing device comprising: a frame including a first extension, a second extension and a body connecting the first extension to the second extension; a retainer device comprising a first retainer arm, a second retainer arm and a bridging arm connecting a first end of the first retainer arm to a first end of the second retainer arm; a plurality of coupling devices extending from the body of the frame, coupling a second end of the first retainer arm of the retainer device and a second end of the second retainer arm of the retainer device to the frame; and a plurality of locking devices incorporated in the frame, locking the frame to an electrical connector to which the frame is to be attached.

In accordance with another embodiment of the present invention, there is provided an electrical connector comprising: an insulative connector housing comprising an elongated terminal base defined in the connector housing for receiving a removable mass storage device, the terminal base having a plurality of electrical terminals wherein first ends of the electrical terminals may be attached to a printed circuit board and second ends of the electrical terminals are used to establish electrical connection with a plurality of terminal slots extending from a device first end of the removable mass storage device, and a plurality of guiding arms extending from the ends of the connector housing away from the terminal base wherein each guiding arm includes a guiding channel configured for use with the removable mass storage device; and a securing device comprising a frame including a first extension, a second extension and a body connecting the first extension to the second extension, a retainer device comprising a first retainer arm, a second retainer arm and a bridging arm connecting a first end of the first retainer arm to a first end of the second retainer arm, a plurality of coupling devices extending from the body of the frame, coupling a second end of the first retainer arm of the retainer device and a second end of the second retainer arm of the retainer device to the frame, and a plurality of locking devices incorporated in the frame, locking the frame to the guiding arms of the connector housing to which the frame is to be attached.

The invention further includes any alternative combination of parts or features mentioned herein or shown in the accompanying drawings. Known equivalents of these parts or features which are not expressly set out are nevertheless deemed to be included.

### BRIEF DESCRIPTION OF THE DRAWINGS

An exemplary form of the present invention will now be described with reference to the accompanying drawings in which:

FIG. 1 is an exploded, perspective view of an electrical connector in accordance with one embodiment of the invention together with a removable mass storage device ready to be inserted;

FIG. 2 is a perspective view of the electrical connector in FIG. 1 with the removable mass storage device ready to be engaged;

FIG. 3 is a perspective view of a securing device in accordance with an embodiment of the invention;

FIG. 4 is a perspective view of the securing device with another embodiment of coupling devices in accordance with the invention;

FIG. 5 is a perspective view of an electrical connector with the securing device in FIG. 4 securing a removable mass storage device when in use;

FIG. 6A is a section view taken from the direction L as shown in FIG. 2 of a securing device aligned to a connector housing of an electrical connector before coupling;

FIG. 6B is a section view of the securing device and the connector housing in FIG. 6A taken from the direction R as shown in FIG. 2;

FIG. 6C is a section view taken from the direction L as shown in FIG. 2 of another securing device aligned to a connector housing of another electrical connector before coupling;

FIG. 6D is a section view of the securing device in FIG. 6C coupled to the connector housing of the electrical connector; and

FIG. 6E is a cross-sectional view of the securing device in FIG. 6C coupled to the connector housing of the electrical connector taken from the direction of O as shown in FIG. 2.

While the above-identified drawing figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale. Like reference numbers have been used throughout the figures to denote like parts.

### DETAILED DESCRIPTION

The demand for removable mass storage devices increases with the advent of new computers, cameras and other electronic equipment. Examples of such removable mass storage devices are CompactFlash™ (CF) card Type I, CF card Type II as well as a CFast card.

When in use, the removable mass storage device is engaged with an electrical connector usually placed at one end of a media slot in electronic equipment where the electrical connector is coupled to the electronic equipment. The removable mass storage device can get disengaged from the electrical connector, e.g., due to the electronic equipment vibration or when the electronic equipment is accidentally dropped. For an electrical connector with a storage device ejector, the removable mass storage card can also be disengaged by the user ejecting the removable mass storage device by accidentally depressing the ejector. When the removable mass storage card is disengaged from the electrical connector, the data reading/writing, processing and/or transmission between the removable mass storage card and the electronic equipment may be affected resulting in data loss.

It would be desirable to provide a securing device for securing a removable mass storage device to an electrical connector. It would also be desirable to provide a securing device that can be used with different types of removable mass storage devices, including but not limited to, the CF Type I, CF Type II and CFast card.

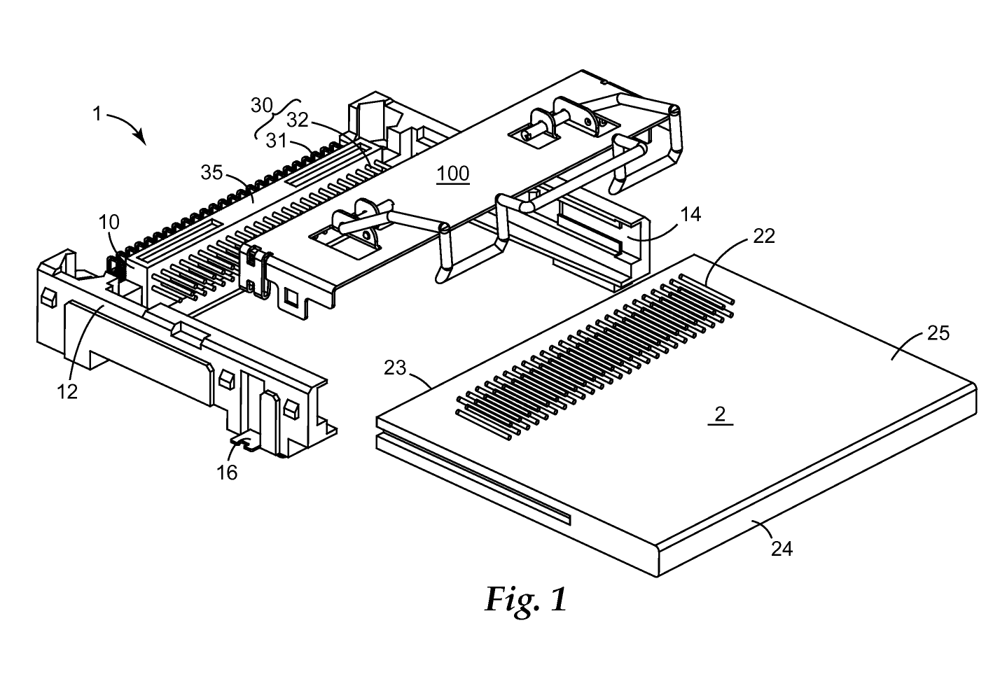

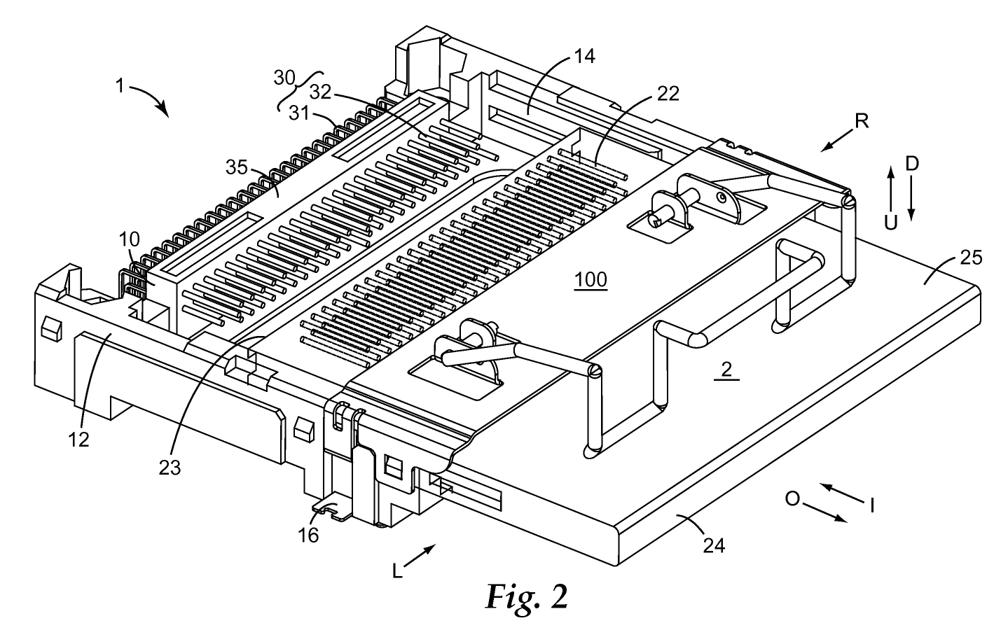

FIG. 1 shows an exploded, perspective view of an exemplary electrical connector in accordance with the present invention with a removable mass storage device such as a CF card ready to be inserted. FIG. 2 is a perspective view of the electrical connector in FIG. 1 with the removable mass storage device ready to be engaged. It is worthwhile to note that while a CF card header connector is used to explain the invention in conjunction with a CF card, the invention is by no means restricted to a CF card header connector or an electrical connector used solely in conjunction with a CF card.

The electrical connector 1 comprises an insulative connector housing 10 comprising an elongated terminal base 35 defined in the connector housing 10 for receiving a removable mass storage device 2, the terminal base 35 having a plurality of electrical terminals 30 wherein first ends 31 of the electrical terminals 30 may be attached to a printed circuit board (not shown) and second ends 32 of the electrical terminals 30 are used to establish electrical connection with a plurality of terminal slots 22 extending from a device first end 23 of the removable mass storage device 2; and a securing device 100 coupled to the connector housing 10.

Extending from the ends of the connector housing 10 away from the terminal base 35 are a plurality of guiding arms 12 wherein each guiding arm 12 includes a guiding channel 14 configured for use with the removable mass storage device 2. In one embodiment, a plurality of solder tabs 16 are coupled to the guiding arms 12 so as to secure the electrical connector 1 to the printed circuit board to prevent lift-off of the electrical connector 1 from the printed circuit board as the removable mass storage device 2 mates with or un-mates from the electrical connector 1.

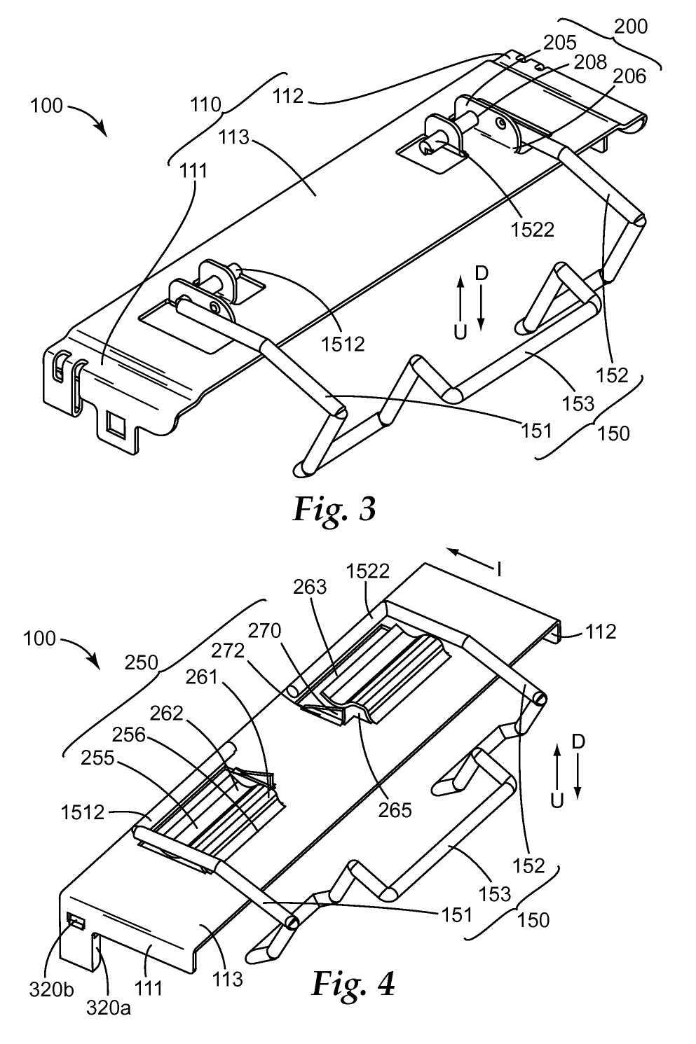

Referring to FIG. 3, the securing device 100 comprises a frame 110 including a first extension 111, a second extension 112 and a body 113 connecting the first extension 111 to the second extension 112, a retainer device 150 comprising a first retainer arm 151, a second retainer arm 152 and a bridging arm 153 connecting a first end of the first retainer arm 151 to a first end of the second retainer arm 152, a plurality of coupling devices 200 extending from the body 113 of the frame 110, coupling a second end 1512 of the first retainer arm 151 of the retainer device 150 and a second end 1522 of the second retainer arm 152 of the retainer device 150 to the frame 110, and a plurality of locking devices incorporated in the frame 110, locking the frame 110 to the guiding arms 12 (not shown) of the connector housing 10 to which the frame 110 is to be attached when the securing device 100 is in use.

In one embodiment, the coupling devices 200 are portions 205 of the body 113 stamped and lifted off the body 113 at one edge 206 of each portions 205. The coupling devices 200 further include a plurality of openings 208 on the portions 205 of the body 113 configured for insertion by the second ends 1512, 1522 of the first and the second retainer arms 151, 152 as the retainer device 150 is coupled to the frame 110.

Preferably, the first retainer arm 151 and the second retainer arm 152 of the retainer device 150 are bent at an angle at their respective second ends 1512, 1522. In FIG. 3, the second retainer arms 151, 152 are bent at an angle of about 90 degrees at their respective second ends 1512, 1522 before they are inserted through the openings 208 on the portions 205 of the body 113. By doing so, the retainer device 150 may be firmly coupled to the frame 110 during use.

While some parts such as the retainer device 150 and the coupling devices 200 may be shown in the figures with apparent linkages, sharp bends or folds, it will be apparent to the person skilled in the art and it is within the spirit of the invention to use, e.g., smooth curves and continuous metal wires. Different shapes and bends may be selected and designed according to the requirements of the retainer device 150 and the coupling devices 200.

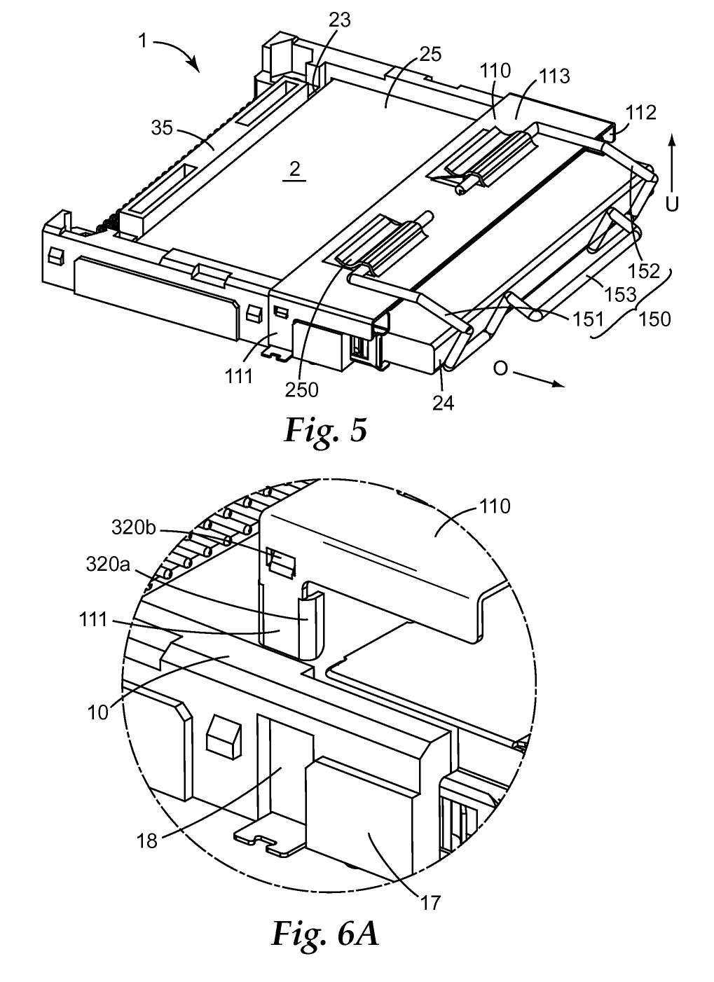

FIG. 4 shows the securing device 100 with another embodiment of a coupling device in accordance with the invention wherein the coupling devices 250 are portions 255 of the body 113 stamped and lifted off the body 113 at one edge 256 of each portions 255 and further bent at a plurality of sections along the portions 255. In the example as shown in FIG. 4, the portions 255 are bent at a first section 261 and a second section 262. In so doing, there is no need to create openings such as holes on the portions 255 and the retainer device 150 may be coupled to the frame 110 by having the second ends 1512, 1522 of the first and the second retainer arms 151, 152 slotted via openings 263 into enclosures 265 formed by the bends at the first sections 261 and retained in place by the bends at the second sections 262.

Preferably, the coupling devices 250 further comprises a plurality of stoppers 270 formed from portions of the body 113 adjacent to the first section 261 of the coupling device 250, stamped and lifted off the body 113 at one edge 272 of each portions. The stoppers 270 serve to minimize the likelihood of the retainer device 150 de-coupling from the frame 110, e.g., as a result of an accidental nudge in the direction I towards the openings 263.

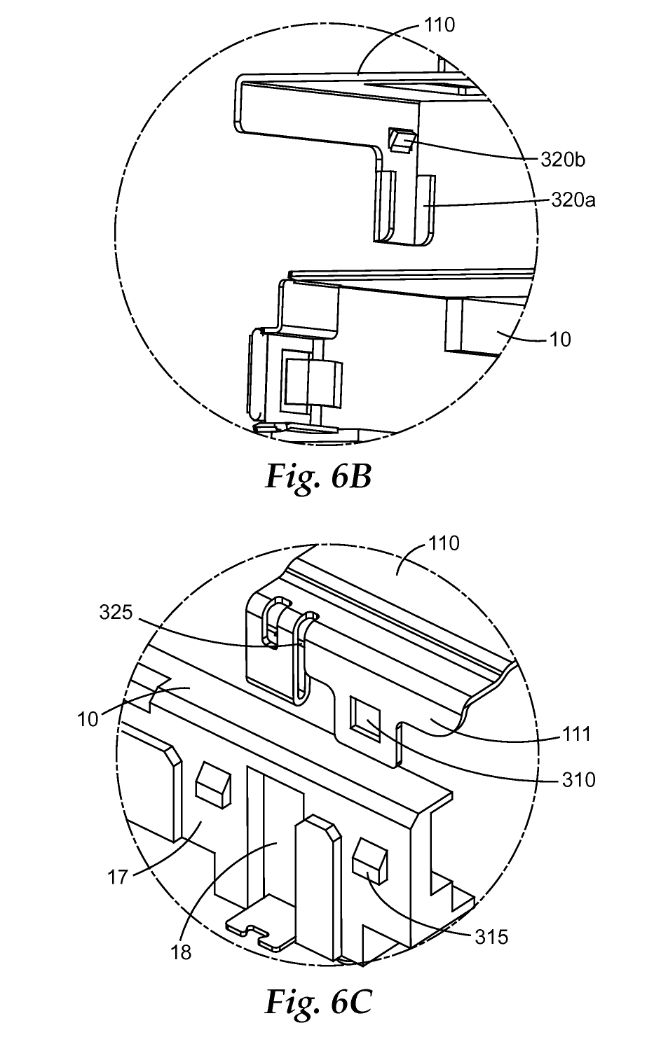

FIG. 5 illustrates how the securing device 100 of the electrical connector 1 may be used to secure the removable mass storage device 2 when in use. With reference to FIG. 2, as the removable mass storage device 2 is inserted in the direction I into the electrical connector 1, the guiding channel 14 on each guiding arm 12 helps to align the removable mass storage device 2 to the terminal base 35 of the electrical connector 1 so that the second ends 32 of the electrical terminals 30 may be properly inserted into the terminal slots 22 extending from the device first end 23 of the removable mass storage device 2 when the removable mass storage device 2 mates with the electrical connector 1. The guiding channel 14 on each guiding arm 12 also helps the proper disengagement of the removable mass storage device 2 from the electrical connector 1 to prevent the accidental damage and/or bending of the second ends 32 of the electrical terminals 30 during the un-mating process.

As the removable mass storage device 2 moves towards the terminal base 35 of the electrical connector 1, the retainer device 150 may either rest on a first surface 25 of the removable mass storage device 2 or be isolated from the removable mass storage device 2 such as in a raised position. If the retainer device 150 is resting on the first surface 25 of the removable mass storage device 2, when the device first end 23 of the removable mass storage device 2 fully mates with the terminal base 35 of the electrical connector 1, the retainer device will slide over a device second end 24 of the removable mass storage device 2 and thus, securing the removable mass storage device 2 to the electrical connector 1.

If the retainer device 150 is isolated from the first surface 25 of the removable mass storage device 2, when the device first end 23 of the removable mass storage device 2 fully mates with the terminal base 35 of the electrical connector 1, the retainer device 150 may be manually lowered (if it was previously in a raised position) in a direction D towards the removable mass storage device 2 until the retainer device 150 fully engages with the device second end 24 of the removable mass storage device 2 and so, securing the removable mass storage device 2 to the electrical connector 1.

To remove the removable mass storage device 2 from the electrical connector 1, the retainer device 150 is first raised in a direction U away from the removable mass storage device 2 so that the retainer device 150 disengages from the device second end 24 of the removable mass storage device. The removable mass storage device 2 may then be removed by applying a pulling force in a direction O to un-mate the removable mass storage device at the device first end 23 from the terminal base 35 of the electrical connector 1.

As the retainer device 150 is coupled to the frame 110 at the body 113, the installation of the retainer device 150 does not add to the physical width of the electrical connector 1. By having the securing device 100 as a separate element that can be attached to a connector housing, the securing device 100 can be used on existing electrical connectors as well as incorporated on different types of electrical connectors.

Referring to FIGS. 3 and 4, during operation, when the retainer device 150 is raised in the direction U prior to the un-mating of the removable mass storage device 2 (not shown) and when the retainer device 150 is lowered in the direction D during the mating of the removable mass storage device 2 to the electrical connector 1 (not shown), the coupling of the second ends 1512, 1522 of the first and the second retainer arms 151, 152 to the coupling devices 200 at the openings 208 or to the coupling devices 250 at the enclosures 265 urge the first and the second retainer arms 151, 152 of the retainer device 150 downwards, resisting any corresponding upward motion due to the movement of the retainer device 150.

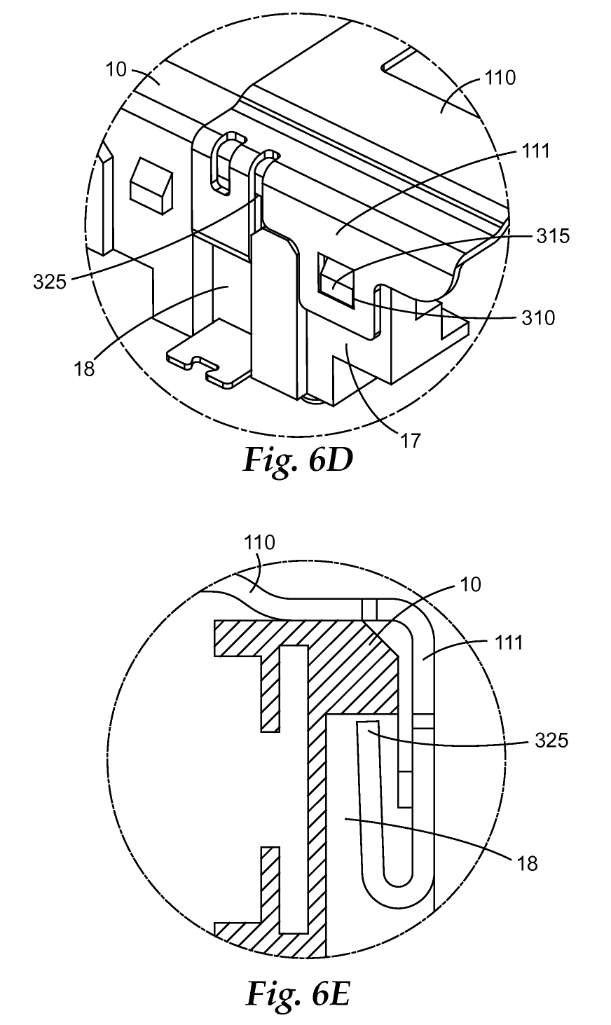

FIGS. 6A, 6B, 6C, 6D and 6E are section views of the securing device 100 with different embodiments of locking devices. In one embodiment, as illustrated by FIGS. 6A and 6B, the securing device 100 comprises locking devices which consist of a plurality of protrusions 320a, 320b extending inwards from the first extension 111 adjacent to a first side 17 of the connector housing 10 and from the second extension 112 (not shown) adjacent to a second side (not shown) of the connector housing 10 to which the frame 110 is to be attached. The securing device 100 may have either protrusions 320a or protrusions 320b or both protrusions 320a and 320b depending on how secure the securing device 100 is to be coupled to the connector housing 10. When the frame 110 is coupled to the connector housing 10, the protrusions 320a, 320b fit into grooves 18 configured on the connector housing 10 adapted to cooperate with the protrusions 320a, 320b thus preventing undesirable lateral movement or lifting of the frame 110 from the connector housing 10, thereby locking the frame 110 firmly to the connector housing 10 of the electrical connector 1.

Referring to FIGS. 6C, 6D and 6E, in one embodiment, the securing device 100 comprises locking devices which comprise a plurality of lock windows 310 included in the first extension 111 and the second extension 112 (not shown) of the frame 110 and a plurality of complementary lock catches 315 configured to cooperate with the lock windows 310 and extending from the connector housing 10 of the electrical connector 1 to which the frame 110 is to be attached. When the frame 110 moves towards the connector housing 10 during coupling as shown in FIG. 6C, the first extension 111 and the second extension 112 (not shown) slide over the lock catches 315 on the connector housing 10 until the lock windows 310 are coupled to the lock catches 315, thereby locking the frame 110 firmly to the connector housing 10 of the electrical connector 1.

In another embodiment, the first extension 111 and the second extension 112 (not shown) of the frame 110 are bent at one end 325 of each extension. When the frame 110 is coupled to the connector housing 10 of the electrical connector 1, the ends 325 of the first extension 111 and the second extension 112 engage with the grooves 18 configured on the connector housing 10 adapted to cooperate with the ends 325 of the first and the second extensions 111, 112 thus preventing the frame 110 from lifting off the connector housing 10 of the electrical connector 1.

The foregoing description of various preferred embodiments of the invention has been presented for purposes of illustration and description. It is not intended to be exhaustive or to limit the invention to the precise forms disclosed, since many modifications or variations thereof are possible in light of the above teaching All such modifications and variations are within the scope of the invention. The embodiments described herein were chosen and described to best explain the principles of the invention and its practical application, thereby to enable others skilled in the art to use the invention in various embodiments and with various modifications as are suited to the particular use contemplated thereof It is intended that the scope of the invention be defined by the claims appended hereto, when interpreted in accordance with the full breadth to which they are legally and equitably suited.

1. A securing device comprising:
a frame including a first extension, a second extension and a body connecting the first extension to the second extension;
a retainer device comprising a first retainer arm, a second retainer arm and a bridging arm connecting a first end of the first retainer arm to a first end of the second retainer arm;
a plurality of coupling devices extending from the body of the frame, coupling a second end of the first retainer arm of the retainer device and a second end of the second retainer arm of the retainer device to the frame; and
a plurality of locking devices incorporated in the frame capable of locking the frame to an electrical connector to which the frame is to be attached.

2. The securing device as claimed in claim 1, wherein the second end of the first retainer arm and the second end of the second retainer arm are bent at an angle.

3. The securing device as claimed in claim 2, wherein the coupling devices include openings configured to receive the second end of the first retainer arm and the second end of the second retainer arm.

4. The securing device as claimed in claim 1 wherein the locking devices comprise a plurality of protrusions extending inwards from the first extension adjacent to a first side of the electrical connector and from the second extension adjacent to a second side of the electrical connector to which the frame is to be attached.

5. The securing device as claimed in claim 1 wherein the first extension and the second extension are each bend at one end.

6. The securing device as claimed in claim 1 wherein the locking devices comprise a plurality of lock windows included in the first extension and the second extension of the frame and a plurality of complementary lock catches configured to cooperate with the lock windows and extending from a connector housing of the electrical connector to which the frame is to be attached.

7. An electrical connector comprising:
an insulative connector housing comprising an elongated terminal base defined in the connector housing for receiving a removable mass storage device, the terminal base having a plurality of electrical terminals wherein first ends of the electrical terminals are attached to a printed circuit board and second ends of the electrical terminals are used to establish electrical connection with a plurality of terminal slots extending from a device first end of the removable mass storage device, and a plurality of guiding arms extending from the ends of the connector housing away from the terminal base wherein each guiding arm includes a guiding channel configured for use with the removable mass storage device; and
a securing device comprising a frame including a first extension, a second extension and a body connecting the first extension to the second extension, a retainer device comprising a first retainer arm, a second retainer arm and a bridging arm connecting a first end of the first retainer arm to a first end of the second retainer arm, a plurality of coupling devices extending from the body of the frame, coupling a second end of the first retainer arm of the retainer device and a second end of the second retainer arm of the retainer device to the frame, and a plurality of locking devices incorporated in the frame, locking the frame to the guiding arms of the connector housing to which the frame is to be attached.

8. The electrical connector as claimed in claim 7 wherein the electrical connector comprises a CompactFlash(CF) header or a CFast header.
